(19) United States
(12) Patent Application Publication
(10) Pub. No.: US 2008/0073165 A1
(43) Pub. Date: Mar. 27, 2008

(54) Brake Disc Assembly for Vehicle Wheels

(76) Inventors: Guido Rau, Radolfzell (DE); Andreas Hecker, Aach (DE); Torsten Rieck, Ratingen (DE)

Correspondence Address: BACHMAN & LAPOINTE, P.C., 900 CHAPEL STREET, SUITE 1201, NEW HAVEN, CT, 06510, US

(21) Appl. No.: 11/662,910

(22) PCT Filed: Aug. 30, 2005
(86) PCT No.: PCT/EP05/09311

§ 371 Date: Oct. 9, 2007

(30) Foreign Application Priority Data
Sep. 16, 2004 (DE) 10 2004 045 327.6

(51) Int. Cl. F16D 65/00; F16D 65/12

(52) U.S. Cl. 188/218 XL

(57) ABSTRACT

A brake disc assembly for vehicle wheels, comprising at least one friction ring and a wheel fixing zone that runs parallel to the friction ring. The friction ring and wheel fixing zone are configured in one-piece from a die-cast material and connecting struts are formed between the friction ring and the wheel fixing zone. The assembly is characterized in that the connecting struts are elastically sprung in a radial and axial direction.

### BACKGROUND OF THE INVENTION

The invention relates to a brake disc assembly for vehicle wheels, comprising at least one friction ring and a wheel fixing zone that runs parallel to the friction ring, whereby the friction ring and the wheel fixing zone are configured in one-piece form from a cast material and whereby connecting struts are formed between the friction ring and the wheel fixing zone.

Different designs of disc brakes are used in vehicle manufacturing to reduce the kinetic energy of the vehicle. The disc brake comprises at least one disc or a friction ring and the corresponding brake shoes and is generally installed between the wheel and the wheel bearing. When the wheels are driven, the brake configuration can be combined with the wheel support. The friction between the friction rings and the brake shoes converts the kinetic energy into thermal energy. The friction rings can in the process reach very high temperatures of up to approximately 850° C. Under the influence of the peripheral speed and of the temperature, the friction rings can deform in a plate-like manner, because they are connected to the wheel only on the inside of the ring. The deformations cause the friction rings to become uneven, which often leads to unpleasant audible brake noises. It is desirable to either reduce or silence these brake noises. Furthermore, the deformations lead to irregular wear of the brake pads.

A generic brake disc assembly is known from EP 1 233 201-A2. The assembly comprises two friction rings that are arranged in parallel and at a distance from one another. A support element is arranged concentrically to the friction rings. The support element is configured in a pot-shaped manner and comprises a fixing zone for the wheel or the rim and a receiving zone for receiving the wheel bearing. The support element is connected to the friction rings via struts. The support element, the struts, and the friction rings are manufactured from a cast. The one end of the strut is connected to the wheel bearing receiving zone and the other end is connected to at least two ribs that are arranged between the friction rings so as to run radially. The central zone of the strut runs at an angle α to the plane of the friction ring. The angle α is to be calculated on the basis of the stress during a braking process.

Based on this state of the art, it is the object of the invention to disclose a brake disc assembly that is simple to produce and wherein the friction rings are deformed as little as possible.

### SUMMARY OF THE INVENTION

This object is achieved by means of a brake disc assembly for vehicle wheels, comprising at least one friction ring and a wheel fixing zone that runs parallel to the friction ring, whereby the friction ring and the wheel fixing zone are configured in one-piece form from a cast material and whereby connecting struts are formed between the friction ring and the wheel fixing zone, whereby the connecting struts are spring-elastic in the radial and/or axial directions.

It is advantageous that, during the braking process, the brake disc assembly has the largest possible room to move. This is achieved by the connecting struts having an undulating profile, whereby the connecting struts run through at least one complete wavelength in the axial direction.

It is also advantageous that the brake disc assembly is constructed as compactly as possible. This is achieved by one end of the connecting struts being connected to the rear friction ring, viewed from the wheel fixing zone.

### BRIEF DESCRIPTION OF THE DRAWINGS

An exemplary embodiment of the invention is described by means of the figures. In said figures:

FIG. 1 is a perspective view onto a brake disc assembly as claimed in the invention,

FIG. 2 is a perspective view onto a partial area of a further brake disc assembly as claimed in the invention,

FIG. 3 shows a section through a partial area of the brake disc assembly of FIG. 2,

FIG. 4 is a perspective view onto a partial area of a further brake disc assembly as claimed in the invention,

FIG. 5 shows a section through a partial area of the brake disc assembly of FIG. 4,

FIG. 6 is a perspective view onto a partial area of a further brake disc assembly as claimed in the invention, and

FIG. 7 shows a section through a partial area of the brake disc assembly of FIG. 6.

### DETAILED DESCRIPTION

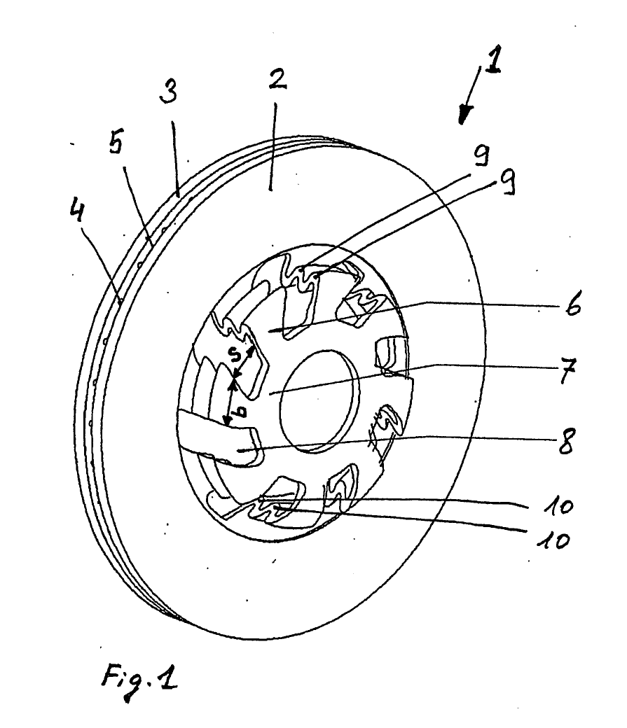

FIG. 1 schematically illustrates a brake disc assembly 1 for vehicle wheels. The brake disc assembly 1 comprises two friction rings 2,3 which are embodied as ring discs that run parallel and are connected to one another by means of ribs 4. During each braking process, the brake shoes act on the outside of the friction rings 2,3 with the brake pads (not illustrated herein). Large through openings 5 are left open between the ribs 4. As a result, the space between the friction rings 2,3 largely remains open for the air that can flow from the inside to the outside through the through openings 5. After each braking process, the outside and the inside of the friction rings 2,3 can thus be cooled.

Connecting struts 6 are configured on the side of the friction rings 2,3 having the smaller diameter, i.e. the inner diameter. The connecting struts 6 serve to connect the friction rings 2,3 to a wheel fixing zone 7 for the vehicle wheel that is also not illustrated herein. The wheel fixing zone 7 can be configured as a flange that has holes for the wheel fixing screws. A hub or an area for receiving the wheel bearing can also be configured between the wheel fixing zone 7 and the connecting struts 6. The wheel receiving zone then runs parallel to the wheel axis and the wheel fixing zone 7 runs perpendicular thereto, i.e. parallel to the braking surfaces of the friction rings 2,3.

The wheel fixing zone 7, the wheel bearing receiving zone, the connecting struts 6, and the friction rings 2,3 are produced as a cast molded part made from a cast. Spaces 8 are visible between the connecting struts 6. It can be seen from FIG. 1 that the spaces 8 have a width s that is approximately as wide as the width b of the connecting struts 6. The connecting struts 6 have an undulating profile. In FIG. 1, the connecting struts 6 run through two complete wavelengths in the axial direction. The connecting struts 6 have alternate recesses 9, 10. A respective inwardly-directed recess 10 follows an outwardly directed recess 9. When, as in FIG. 1, the undulating profile runs through two complete wavelengths, two recesses 9 are configured on the outside and two recesses 10 are configured on the inside of the connecting struts 6. Undulating profiles with a plurality of wavelengths that have been completely run through or with less than one wavelength are also possible.

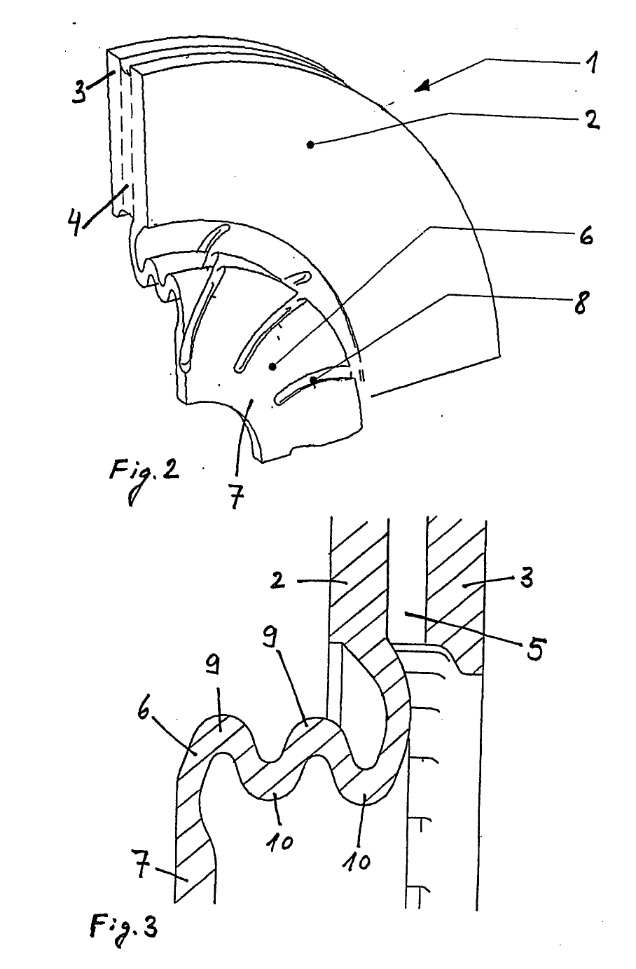

FIG. 2 and FIG. 3 illustrate a further exemplary embodiment of the brake disc assembly 1 as claimed in the invention. The spaces 8 between the connecting struts 6 have a considerably smaller width s than in FIG. 1. The connecting struts 6 have a width b that is at least twice as large as the width s of the spaces 8. It can be seen from FIG. 2 how the spaces 8 are configured similarly to slits. By means of a suitable casting mold and by means of a well-controlled casting method, spaces 8 that have a width s of only a few millimeters can be configured. The slit-shaped spaces 8 and the connecting struts 6 are configured in a spiral herein, for example. The spiral course of the spaces 8 can be seen particularly well in the first portion of the connecting struts 6 that is configured in the flat zone, directly adjacent the wheel fixing zone 7. As a result of this the connecting struts 6 are as inflexible and deformation-free as possible when the stress is applied to the wheel during a braking process in the rotational direction of the wheel. At the same time, also as a result of this the connecting struts 6 permit an elastic, flexible deformation in the direction of expansion that is a result of the temperature increase of the friction rings 2,3. The spaces 8 can also be radial or tangential.

A further possibility is to make the spaces 8, viewed from the wheel fixing zone 7, broad at first, and then increasingly narrower. The width b of the connecting struts 6 increases here constantly from the wheel fixing zone 7 to the attachment on the friction rings 2,3. It can be seen from the sectional view of FIG. 3 how the connecting struts 6 are attached to the friction ring 2 located at the very front, viewed from the wheel fixing zone 7. When mounted, the front friction ring 2 is located at the outside of the vehicle.

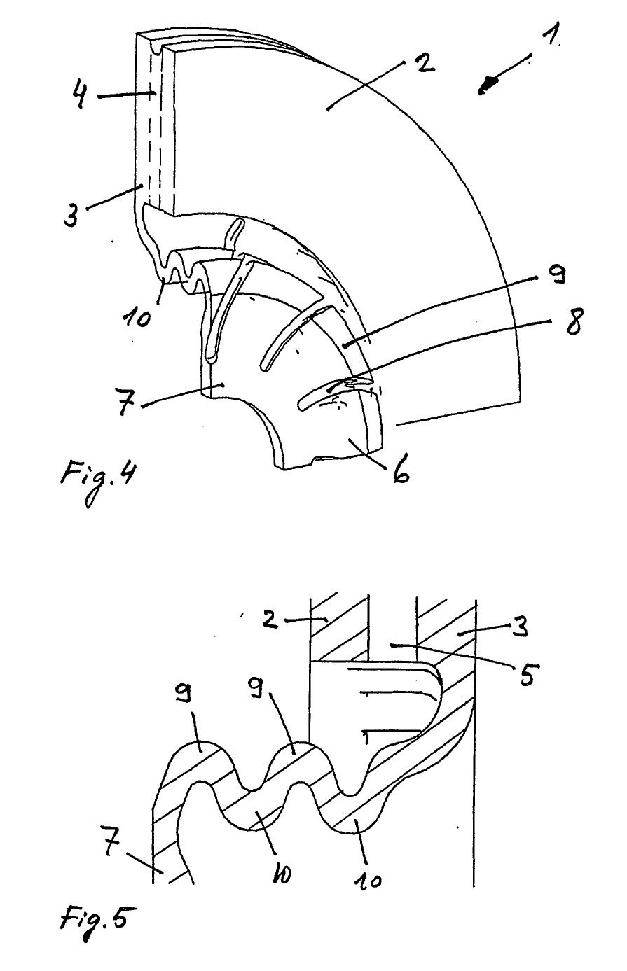

FIGS. 4 and 5 illustrate a further alternative of the brake disc assembly as claimed in the invention. The difference from the alternative FIGS. 2 and 3 lies in the attachment of the connecting struts 6 in the friction ring 3 located at the very end, i.e. the friction ring located on the inside. The attachment of the friction rings 2,3 to the wheel fixing zone 7 can be configured in an axially and radially spring-elastic manner by suitable dimensioning of the connecting struts 6 and the spaces 8.

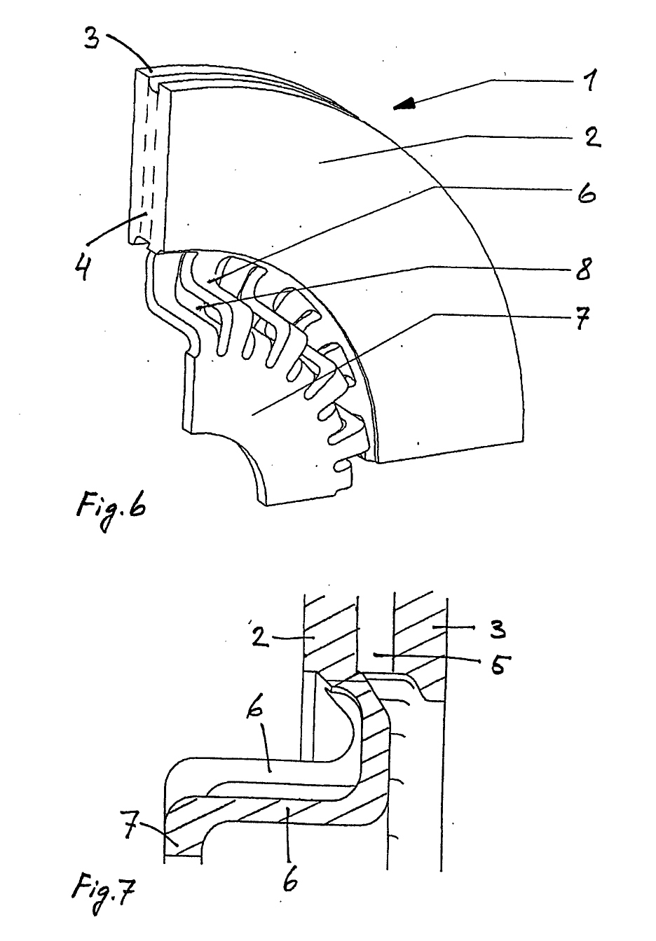

FIGS. 6 and 7 illustrate a further exemplary embodiment of the brake disc assembly 1. It can be seen here how the connecting struts 6 are alternately arranged connected to the outer friction ring 2 and to the inner friction ring 3. This alternating attachment results in a parallelogram so that a parallel outward displacement of the friction rings 2,3 is made possible when a thermal stress occurs. A plate-like deformation of the friction rings 2,3 is prevented. The configuration and the arrangement of the connecting struts 6 can be adapted to the mechanical and thermal stresses that are expected in response to the braking processes. The brake disc assembly 1 can be configured for all types of vehicle wheels, such as, for example, for wheels of trucks, passenger cars, motorcycles, rail cars or aircraft.

1-11. (canceled)

12. A brake disc assembly (1) for vehicle wheels, comprising at least one friction ring (2,3) and a wheel fixing zone (7) that runs parallel to the at least one friction ring (2,3), whereby the at least one friction ring (2,3) and the wheel fixing zone (7) are in one-piece form from a cast material and whereby connecting struts (6) are formed between the at least one friction ring (2,3) and the wheel fixing zone, wherein the connecting struts (6) are spring-elastic in radial and/or axial directions.

13. The brake disc assembly (1) as claimed in claim 12, wherein the connecting struts (6) have an undulating profile, whereby the connecting struts (6) run through at least one complete wavelength in the axial direction.

14. The brake disc assembly (1) as claimed in claim 12, wherein the connecting struts (6) have an undulating profile, whereby the connecting struts (6) run through less than one complete wavelength in the axial direction.

15. The brake disc assembly (1) as claimed in at least one of claims 12 to 14, wherein one end of the connecting struts (6) is connected to the rear friction ring (3), when viewed from the wheel fixing zone (7).

16. The brake disc assembly (1) as claimed in at least one of claims 12 to 14, wherein one end of the connecting struts (6) is connected to the front friction ring (2), when viewed from the wheel fixing zone (7).

17. The brake disc assembly (1) as claimed in at least one of claims 12 to 14, wherein one end of the connecting struts (6) is alternately connected with the front friction ring (2) and the rear friction ring (3), when viewed from the wheel fixing zone (7).

18. The brake disc assembly (1) as claimed in at least one of claims 12 to 14, wherein the connecting struts (6) have a width (b) which is substantially as wide as a space (s) which is between two adjacent connecting struts.

19. The brake disc assembly (1) as claimed in at least one of claims 12 to 14, wherein the connecting struts (6) have a width (b) which is substantially wider than a space (s) which it configured between two adjacent connecting struts.

20. The brake disc assembly (1) as claimed in at least one of claims 12 to 14, wherein the connecting struts (6) have a width (b) which widens towards the friction rings (2,3), when viewed from the wheel fixing zone (7).

21. The brake disc assembly (1) as claimed in at least one of claims 12 to 14, wherein the connecting struts (6) run radially towards the friction rings (2,3), when viewed from the wheel fixing zone (7).

22. The brake disc assembly (1) as claimed in at least one of claims 12 to 14, wherein the connecting struts (6) run in a spiral towards the friction rings (2,3), when viewed from the wheel fixing zone (7).
